(19) United States
(12) Patent Application Publication
(10) Pub. No.: US 2005/0188421 A1
(43) Pub. Date: Aug. 25, 2005

(54) System and method for providing data security

(76) Inventor: Pierre Elie Arbajian, Matthews, NC (US)

Correspondence Address: HOFFMAN WARNICK & D'ALESSANDRO, LLC, 3 E-COMM SQUARE, ALBANY, NY, 12207, US

(21) Appl. No.: 10/785,142

(22) Filed: Feb. 24, 2004

(51) Int. Cl. G06F 11/30; H04L 9/00

(52) U.S. Cl. 726/4; 713/166

(57) ABSTRACT

A data security system, comprising: an implicit clearance system for requiring a user to meet any one of a set of implicit conditions in order access the set of data; an explicit clearance system for selectively requiring a user to have explicit permission in order to access a set of data; a field level clearance system for limiting access to data records by restricting the user to a predefined view, wherein the predefined view displays a predetermined set of data fields from the data records; and a data anonimazation system for replacing a data element in a data record with a unique identifier in order to keep the data record anonymous.

### BACKGROUND OF THE INVENTION

1. Technical Field

The present invention relates generally to data security, and more specifically relates to a multi-purpose, modular security architecture for data warehouses.

2. Related Art

As the importance of information technology continues to grow for businesses and other such organizations, managing the security of the data has become an important challenge. In particular, systems are required that restrict access to data to some users, while allowing access to others.

In most data warehouses, data is stored in rows within a table. Each row generally includes several fields, which may for example include a name, an account number, transaction data, personal financial data, etc. Often, much of the information in a data warehouse is of a sensitive nature, and therefore requires safeguards to ensure that access to the information is restricted. At the same time, the organization typically wants to be able to utilize the data for legitimate business purposes.

One method for restricting data access is to aggregate the data. In other words, information, such as sales over a particular time period or sales to a particular geography are collected and aggregated. In this manner, users do not access the actual data, but rather view only a summary of the data. Unfortunately, aggregation processes can become complex because averaging and summarization is not always simple and/or easily agreed upon.

Moreover, as organizations become more complex, data viewing restrictions can also become complex and require greater flexibility. For instance, an organization may have offices in different countries that have different privacy standards; it may have different divisions that have different access requirements; it may have individuals within the organization that require complete access to some data, but not other data; it may have data that requires anonymity; etc. Accordingly, a need exists for a comprehensive and integrated security system that can provide multiple types of data viewing restrictions.

### SUMMARY OF THE INVENTION

The present invention addresses the above-mentioned problems, as well as others, by providing a security system that can restrict data access based on implicit permission, explicit permission, field level permission, and data anonimization. In a first aspect, the invention provides a data security system, comprising: an implicit clearance system; an explicit clearance system; a field level clearance system; and a data anonimazation system.

In a second aspect, the invention provides a program product stored on a recordable medium for providing data security, the program product comprising: means for selectively requiring a user to have explicit permission in order to access a set of data; means for requiring the user to meet any one of a set of implicit conditions in order to access the set of data; means for limiting access to data records by restricting the user to a predefined view, wherein the predefined view displays a predetermined set of data fields from the data records; and means for replacing a data element in a data record with a unique identifier in order to create an anonymous data record.

In a third aspect, the invention provides a method for providing data comprising: selectively replacing data elements in data records with unique identifiers as the data records are being stored in a data warehouse in order to create anonymous data records; selectively requiring a user to have explicit permission in order to access a set of the data records; requiring the user to meet any one of a set of implicit conditions in order access the set of the data records if explicit permission is not required; and limiting access to data records by restricting the user to a predefined view, wherein the predefined view displays a predetermined set of data fields from the data records.

### BRIEF DESCRIPTION OF THE DRAWINGS

The embodiments of this invention will be described in detail, with reference to the following figures, wherein like designations denote like elements, and wherein:

FIG. 1 depicts a security system in accordance with an embodiment of the present invention.

FIG. 2 depicts a flow diagram of an implicit clearance method in accordance with an embodiment of the present invention.

FIG. 3 depicts a flow diagram of an explicit clearance method in accordance with an embodiment of the present invention.

### DETAILED DESCRIPTION OF THE INVENTION

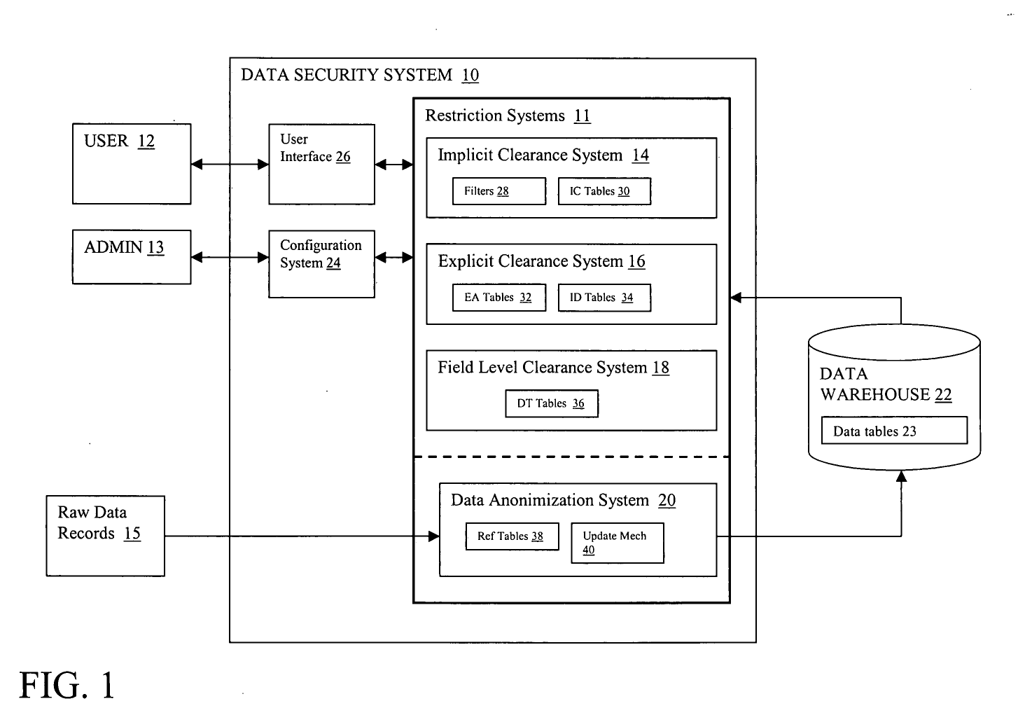

Referring now to the drawings, FIG. 1 depicts an overview of a data security system 10 that is configured to restrict access to a data warehouse 22. In particular, data security system 10 grants, denies or limits access to data warehouse 22. Data warehouse 22 may comprise any type of data, which could reside at one or more physical locations, in one or more formats. In a typical embodiment, data warehouse 22 comprises one or more data tables 23, each comprising one or more rows of data, wherein each row represents a data record. Each row is divided into a set of fields, with each field capable of holding a data element. Thus, a data table generally comprises a two-dimensional data structure having a first dimension of a predetermined length comprising columns or fields and a second dimension of varying length that comprises rows.

Access to the data in warehouse 22 is controlled by a set of restriction systems 11, which can be configured with a configuration system 24, e.g., by an administrator 13, to meet the particular needs of the organization. Restriction systems 11 include an implicit clearance system 14, an explicit clearance system 16, a field level clearance system 18, and a data anonimization system 20. A user interface 26, such as those commonly known in the art may also be provided. Implicit clearance system 14, explicit clearance system 16, and field level clearance system 18 grant, deny or limit access whenever a user 12 requests a data record from data warehouse 22. Systems 14, 16, 18 generally grant access to data based upon privileges afforded to the user 12. As described below, these privileges may be derived based on variety of factors, including: (1) explicit permission, e.g., based on the identity (ID) of the user, and (2) implicit permission based on factors such as the geographic location of the user, the division to which the user belongs, the job level or type of the user, etc.

Data anonimization system 20 provides a mechanism for storing raw data records 15 in an anonymous fashion, such that very sensitive data elements can be kept secret from all users 12.

As noted above, when implementing data warehouses, designers are faced with data security related challenges that require several types of data viewing restrictions. Firstly, data in large organizations often must be made available implicitly on a business unit by business unit basis or on a country-by-country basis or even on an employee-by-employee basis. Secondly, access to some sectors of an organization's data requires explicit permission and cannot be inherited from implicit grants. Thirdly, access to data can be subject to restrictions based on the data viewer role. Fourthly, it is at times necessary to provide access to anonymized data, e.g., data that involves a transaction related to an individual without divulging the identity of the individual.

This present invention provides a complete approach to satisfy the four requirements described above. This is achieved with:

1. An implicit clearance system 14 that can operate at the row level (or higher) using a multiple filter approach. As described below, each filter is capable of checking an implicit condition, which may or may not be met by user 12.

2. An explicit clearance system 16 that can also operate at the row level (or higher) to determine if access to an area of data (e.g., row, set of rows, table, set of tables, etc.) requires explicit permission. The explicit security requirement addresses a special challenge that arises from the implicit security system 14. Namely, in some instances, some areas of an information warehouse are off limits to all but a few select users. Explicit security system 16 provides a mechanism for identifying those areas in the data warehouse 22 that require explicit authorization, thus providing an extra measure of security to especially sensitive data records.

3. Field level clearance system 18 provides sub row level (i.e., field level) clearance. In today's databases, information is typically organized by rows in tables, and each row has multiple fields. It is desirable at times to define types of data, such as payment activities, demographic data, etc., and then provide access to such data by type. Thus, one user may have access to payment/financial data and another one may have access to demographic data and a third user would be granted access to all types. Field level clearance system 18 thus allows distribution of privileges by type of data.

4. Data anonimization system 20 provides a mechanism for allowing data to be viewed without disclosing certain personal details. Often, certain classes of end users are entitled to view averages and aggregations of data but not the details. Details of the data are suppressed to prevent a user from identifying individuals' identities or other sensitive information about the data. The problem with aggregation is that it can require a large number or possibilities for each value and the aggregation of the aggregated data presents its own set of challenges. Anonimizing the sensitive data in a record is an effective way to suppress the values in a record without compromising the granularity of the data. Data anonimization system 20 provides the ability to do just that.

Each of the restriction systems 11 is modular and can be implemented (or not implemented) at various degrees depending on particular requirements and the availability of resources. In the exemplary embodiments described herein, the invention is implemented using a set of security tables 30, 32, 34, 36, 38 that determine the proper grants and privileges afforded to different users (e.g., based on user ID's), and conditions that allow access or suppress access based on the content of the data records. The security tables are specific to each system 14, 16, 18, 20, however some overlap is possible. It should be understood that term “security table,” as used herein, is meant to describe any system or format for storing information (e.g., a data structure, a file, a data object, etc.), and therefore should not be limited in any manner to a particular data format.

Implicit Clearance System

Implicit clearance system 14 includes a set of filters 28 that check implicit conditions of the user 12. Exemplary implicit conditions may for instance include the country, division, business unit, etc., of the user 12. Implicit clearance system 14 allows the user 12 access to requested data provided the user meets at least one of the conditions set defined any one of the filters 28. Thus, whenever a user meets a condition of one of the filters (e.g., country access), then the user 12 will be granted implicit clearance and no other filter checks are necessary.

Implicit clearance system 14 includes one implicit clearance (IC) table 30 for each filter 28. For instance, for a country filter, the associated IC table 30 would list all user ID's belonging to the allowed country. For example, IC table 30 may include the following information for an associated country filter:

IC TABLE

| | |
|---|---|
| 1. | Allowed Countries = USA, CANADA, UK |
| 2. | USER ID's in the Allowed Countries = SMITH123, |
| | JONES124, |
| | JOHNSON111, |
| | Etc. |

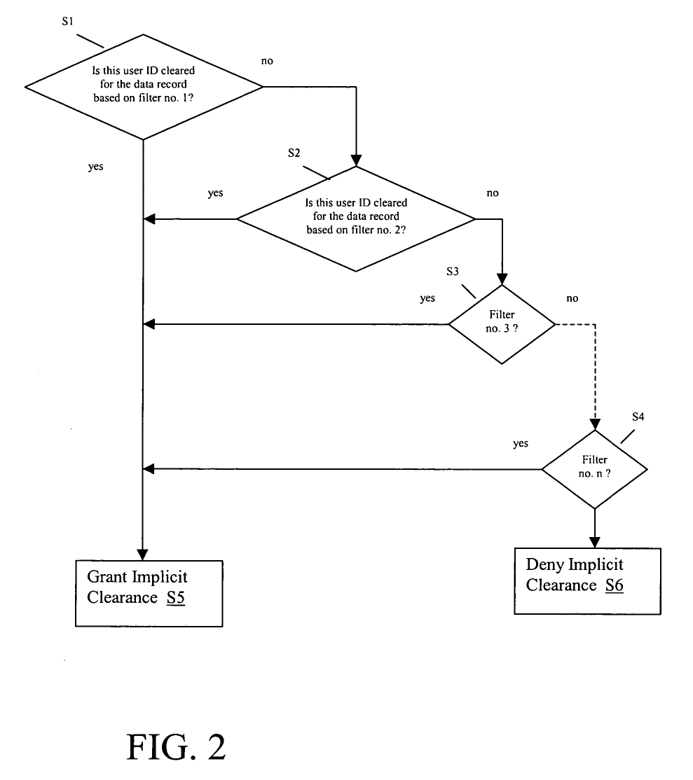

FIG. 2 depicts a flow chart showing an exemplary implicit clearance process. At step S1, a check is made to see if the user ID is cleared to see the requested data record based on a first filter (i.e., filter no. 1). If the user does not have clearance, then a check is made at step S2 to see if the user ID is cleared to see the data record based on a filter no. 2. This process is repeated (e.g., in steps S3 and S4) until either the user ID meets a condition of one of the filters 28 and is granted clearance at step S5, or the user ID fails to meet a condition of any of the filters 28 and is denied access at step S6.

Explicit Clearance System

As a precursor to implicit clearance, explicit clearance system 16 first checks to see if the data record being sought requires explicit clearance. If explicit clearance is required, then a check is made to see if the user ID has explicit clearance, and access is granted accordingly. If no explicit clearance is required, then the implicit clearance system 14 is initiated for the record being sought.

To implement this system 16, two sets of security tables are utilized, explicit areas (EA) tables 32 and user ID tables 34. The EA table set 32 identifies the areas in the data warehouse 22 that require explicit clearance and the ID table set 34 grants explicit access to user ID's for the areas covered by the first set. An exemplary EA and ID table are depicted below.

EA TABLE

Restricted Areas
1. Division: Government Contract Division
2. Division: Military Industries Division
Etc.

ID TABLE

| Restricted Area | USERS having explicit permission |
|---|---|
| Government Contract Division | SMITH123, JACOBS111, etc. |

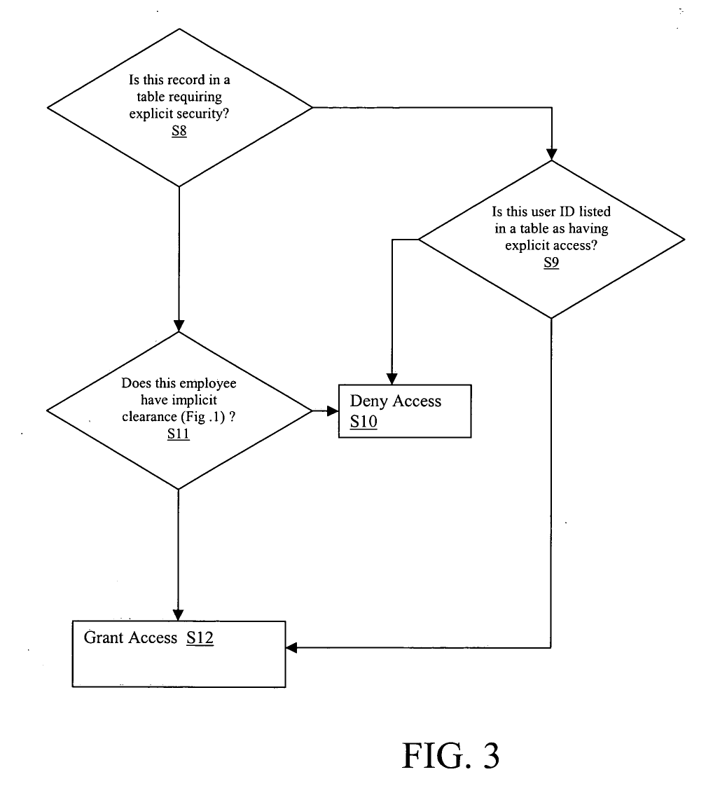

FIG. 3 depicts an exemplary flow chart of the process. In the first step S8, a check is made to see if the data sought is listed in the set of EA tables 32 requiring explicit security. If it is not, then a check is made to see if the employee has implicit clearance at step S11, using the implicit clearance system 14 described above with reference to FIG. 1. If explicit clearance is required, then a check is made at step S9 to see if the user ID is listed in one of the ID tables 34 granting explicit access. If the user ID is not listed, then access is denied at step S10. Otherwise, if the user ID is listed, access is granted at step S12.

Field Level Clearance System

Field level clearance system 18 includes a set of data type (DT) tables 36 that dictates data types available for different users. Field level clearance system 18 may share the same set of tables with the implicit clearance system tables because the areas of coverage and the filters are likely to be the same for both.

As data is divided into types (e.g., financial, demographic, etc.), and the various types are presented as different views, access is granted by the data type, and thus by the particular view sought be the user 12. Accordingly, a user 12 can only display a requested data type view of a data record if the user has field level clearance to see that type of view. For instance, consider the hypothetical case of human resource data that includes employee information. Field level clearance system 18 provides a mechanism that allows the data to be presented in different views (in this example, three views):
1. Financial View: Employee Business Unit, Employee number, and Employee Salary.
2. Demographic View: Employee Business Unit, Employee number, Employee Age, and Years employed.
3. Complete View: Employee Business Unit, Employee number, Employee Salary, Employee Age, and Years employed.

Thus, data access can be controlled by the particular view sought by the user 12. In the DT tables 36, each user ID includes a set of privileges granted to the user for viewing data. Thus, particular fields of data (e.g., salary) can be included in views only for those users 12 that require such access. An administrator 13 could set up the views in a manner that is known in the art. Below is an example of a DT table 36.

DT TABLE

| USER ID | PERMITTED VIEWS |
|---|---|
| SMITH001 | Financial |
| JONES123 | Complete |

Data Anonimization System

Data anonimization system 20 provides a mechanism for anonimizing data elements as they are read into the data warehouse 22. Thus, for example, sensitive data such as customer names, social security numbers, etc., can be made anonymous at the time they are stored. Each field that requires anonymity includes an associated reference table 38 that provides unique (and secret) identifiers for data elements being stored into the data table. If a unique identifier does not exist in the associated reference table 38 for a data element, data anonimization system 20 includes an update mechanism 40 that generates the identifier and updates the respective table.

For instance, consider a table of data that included rows of sales data having the following fields:

| | | | | | Commission |
|---|---|---|---|---|---|
| Date | Customer | Item | Sale amount | Employee | Paid |
| Jan. 1, 2004 | Big Co. | 123 | $10,000 | Smith | $800 |
| Jan. 3, 2004 | Small Co. | 122 | $10,000 | Jones | $500 |

Storing the data in this manner may be problematic, as it may be desirable to keep the customer and employee name anonymous to the users viewing the data. To handle this situation, the above data can be stored by data anonimization system 20 in an anonymous format utilizing a customer reference table and an employee reference table. Whenever a record is read into the data warehouse 22, the reference tables 38 are accessed to obtain a unique identifier for the customer and employee name contained in the record. The customer and employee name are then replaced with the identifier. If a unique identifier does not exist in the associated reference table 38 for a data element (such as a specific company name), data anonimization system 20 automatically generates the identifier and updates the respective table. The anonimized table of data therefore would appear as follows:

| | | | | | Commission |
|---|---|---|---|---|---|
| Date | Customer | Item | Sale amount | Employee | Paid |
| Jan. 1, 2004 | px92k | 123 | $10,000 | a23sdd | $800 |
| Jan. 3, 2004 | kl284 | 122 | $10,000 | 1asjk99 | $500 |

Thus, as can be seen, predetermined columns (i.e., fields) in the data table can be made anonymous without the need to average or aggregate the data.

It is understood that the various devices, modules, mechanisms and systems described herein may be realized in hardware, software, or a combination of hardware and software, and may be compartmentalized other than as shown. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program product, or software, in the present context mean any expression, in any language, code or notation, of a set of instructions intended to cause a system having an information processing capability to perform a particular function either directly or after the following: (a) conversion to another language, code or notation; and/or (b) reproduction in a different material form.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

1. A data security system, comprising:
an implicit clearance system;
an explicit clearance system;
a field level clearance system; and
a data anonimization system.

2. The data security system of claim 1, wherein the implicit clearance system comprises a mechanism for setting up a plurality of filters for a set of data, and wherein a user is granted permission to the set of data if the user meets a condition of at least one filter.

3. The data security system of claim 2, wherein the set of data is selected from the group consisting of: a row of data, a data table, and a data field.

4. The data security system of claim 1, wherein the implicit clearance system comprises a table for each filter, wherein each table lists all user ID's that meet the condition of an associated filter.

5. The data security system of claim 1, wherein the explicit clearance system comprises a mechanism for requiring explicit permission to an area of data, and wherein a user is granted permission to the area of data only if explicit permission has been granted.

6. The data security system of claim 5, wherein the area of data is selected from the group consisting of: a row of data, a data table and a data field.

7. The data security system of claim 1, wherein the explicit clearance system comprises:
an explicit areas table that defines all areas of data that require explicit clearance; and
a set of ID tables that define those users who have explicit clearance for each of the areas requiring explicit permission.

8. The data security system of claim 1, wherein the field level clearance system controls access to data types by restricting a user to a predefined view, wherein the predefined view displays a predetermined set of data fields.

9. The data security system of claim 8, wherein the field level clearance system includes a set of data type tables that dictates data types available to each of a plurality of users.

10. The data security system of claim 1, wherein the anonimization system provides a mechanism for replacing a data element in a data record with a unique identifier in order to keep the data record anonymous.

11. The data security system of claim 10, wherein the anonimization system includes:
a reference table for each data field that is to be kept anonymous, wherein each reference table includes a list of anonimized data elements and an associated unique identifier; and
a mechanism for generating a new unique identifier for a data element that does not exist in the list of anonimized data elements.

12. A program product stored on a recordable medium for providing data security, the program product comprising:
means for selectively requiring a user to have explicit permission in order to access a set of data;
means for requiring the user to meet any one of a set of implicit conditions in order access the set of data;
means for limiting access to data records by restricting the user to a predefined view, wherein the predefined view displays a predetermined set of data fields from the data records; and
means for replacing a data element in a data record with a unique identifier in order to create an anonymous data record.

13. The program product of claim 12, wherein the means for selectively requiring a user to have explicit permission comprises:
means for defining all areas of data that require explicit clearance; and
means for defining those users who have explicit clearance for each of the areas requiring explicit permission.

14. The program product of claim 12, wherein the means for requiring the user to meet any one of a set of implicit conditions comprises means for storing a set of acceptable user ID's for each of the implicit conditions.

15. The program product of claim 12, wherein the means for limiting access to a data record includes means for associating each of a plurality of users with one of the predefined views.

16. The program product of claim 12, wherein the means for replacing a data element in a data record with a unique identifier includes:
reference means for each data field that is to be kept anonymous, wherein said reference means includes a list of anonimized data elements and an associated unique identifier; and
means for generating a new unique identifier for a data element that does not exist in the list of anonimized data elements.

17. A method for providing data security, comprising:
selectively replacing data elements in data records with unique identifiers as the data records are being stored in a data warehouse in order to create anonymous data records;
selectively requiring a user to have explicit permission in order to access a set of the data records;
requiring the user to meet any one of a set of implicit conditions in order access the set of the data records if explicit clearance is not required; and
limiting access to data records by restricting the user to a predefined view, wherein the predefined view displays a predetermined set of data fields from the data records.

18. The method of claim 17, wherein the step of selectively requiring a user to have explicit permission comprises:
defining all areas of data that require explicit clearance; and
defining those users who have explicit clearance for each of the areas requiring explicit permission.

19. The method of claim 17, wherein the step of requiring the user to meet any one of a set of implicit conditions includes the step of storing a set of acceptable user ID's for each of the implicit conditions.

20. The method of claim 17, wherein the step of limiting access to a data record includes the step of associating each of a plurality of users with one of the predefined views.

21. The method of claim 17, wherein the step of replacing a data element in a data record with a unique identifier includes:
providing a reference table for each data field that is to be kept anonymous, wherein said reference table includes a list of anonimized data elements and an associated unique identifier; and
generating a new unique identifier for a data element that does not exist in the list of anonimized data elements.
